(19) United States
(12) Patent Application Publication
(10) Pub. No.: US 2024/0150527 A1
(43) Pub. Date: May 9, 2024

(54) LIQUID VINYL FUNCTIONALIZED CAGE-TYPE POLYHEDRAL OLIGOMERIC SILSESQUIOXANE MODIFIED BY LOW-MOLECULAR-WEIGHT POLYSILOXANE AND PREPARATION METHOD THEREOF

(71) Applicant: Hangzhou Normal University, Hangzhou (CN)

(72) Inventors: Lianbin WU, Hangzhou (CN); Hui LI, Hangzhou (CN); Yingqian HU, Hangzhou (CN); Zaoxia WEN, Hangzhou (CN); Wenxiu CHEN, Hangzhou (CN)

(21) Appl. No.: 18/382,037

(22) Filed: Oct. 19, 2023

(30) Foreign Application Priority Data
Oct. 20, 2022 (CN) 202211286199X

(51) Int. Cl. C08G 77/38; C07F 7/21

(52) U.S. Cl. CPC C08G 77/38; C07F 7/21

(57) ABSTRACT

Disclosed are liquid vinyl functionalized cage-type polyhedral oligomeric silsesquioxane modified by low-molecular-weight polysiloxane and a preparation method thereof. Under the catalytic action of tris(pentafluorophenyl)borane, cage-type octakis (dimethylsiloxy)-T8-silsesquioxane and hetero telechelic polydimethylsiloxane undergo a Piers-Rubinsztajn reaction, to obtain liquid Vi-POSS. Side chains of the liquid vinyl functionalized POSS in the present disclosure are Si—O—Si chain links, have better heat stability than that of common long-carbon-chain side chains, and contain vinyl functional groups capable of participating in chemical reactions, which not only have good mechanical enhancement and heat resistance properties, but also have chemical reactivity.

### TECHNICAL FIELD

The present disclosure relates to the technical field of POSS preparation processes, in particular to liquid vinyl functionalized cage-type polyhedral oligomeric silsesquioxane (POSS) modified by low-molecular-weight polysiloxane and a preparation method thereof.

### BACKGROUND ART

At present, organosilicone materials have been widely developed and applied to fields such as medical health, construction, industrial production and aerospace. Wherein, cage-type polyhedral oligomeric silsesquioxane (POSS), as a typical nano-material, has become one of the important objects of modified polymers.

A structural general formula of the POSS is (RSiO_{1.5})ₙ, and a structure of the POSS is between inorganic silicon dioxide (SiO₂) and organic pure silicon resin (R₂SiO) n, which combines comprehensive properties of inorganic silicon materials and organosilicon materials. Its core is a SiO₂-like cage-type structure, which can provide materials with stability, rigidity and excellent heat stability properties. A periphery can be connected with inert or reactive organic groups, such that the materials have the characteristics of reactivity and flexibility. Structures of side chains and organic groups connected to the periphery of the POSS can be designed according to different product purposes, which can improve the compatibility and reactivity with other polymer matrices, so as to obtain nano composite materials with more excellent properties.

At present, the POSS is mainly designed and applied in a solid state. Mechanical properties and heat stability properties of base material systems can be improved by adding a small amount of the POSS, however, the problem of severe precipitation and agglomeration of the POSS will be caused as the use amount increases, thereby posing a negative impact on the transparency of the systems and comprehensive properties of the materials.

Chinese patent CN102241937A has disclosed a POSS-modified water-based nano transparent thermal insulation coating and a preparation method thereof. Solid vinyl POSS and acrylic monomers undergo a free radical reaction, to prepare liquid POSS with long side chains. Chinese patent CN111116915A has disclosed liquid methacrylate functionalized POSS, photo-cured acrylic resin modified by the same, and a preparation method of the liquid methacrylate functionalized POSS. Liquid POSS with high compatibility with a base material is provided, which can effectively solve the problem of agglomeration and precipitation of the POSS. The liquid POSS is obtained by a hydrosilylation reaction between allyl methacrylate containing long carbon chains and solid polyhedral oligomeric silsesquioxane, however, application fields of the POSS will be greatly limited due to the presence of C—C bonds.

### SUMMARY

The first objective of the present disclosure is to provide novel liquid vinyl functionalized POSS modified by low-molecular-weight polysiloxane to overcome the defects in the prior art.

In order to achieve the above objective of the present disclosure, the present disclosure is achieved by the following technical solution:

A structural formula of liquid vinyl functionalized POSS (Vi-POSS) modified by low-molecular-weight polysiloxane is shown in Formula 1:

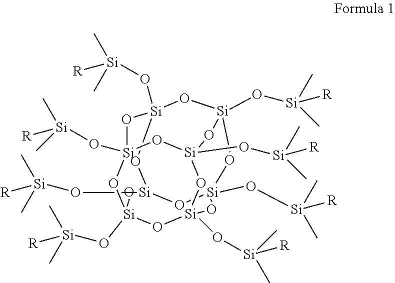

where, R represents a low-molecular-weight polysiloxane group, namely

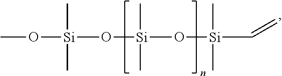

and n is any integer from 2 to 18.

The second objective of the present disclosure is to provide a preparation method of the liquid vinyl functionalized POSS, including the following steps:
making cage-type octakis(dimethylsiloxy)-T8-silsesquioxane (Q-type H-POSS) and hetero telechelic polydimethylsiloxane undergo a Piers-Rubinsztajn reaction (P-R reaction) under a catalytic action of tris(pentafluorophenyl)borane, to obtain liquid Vi-POSS.

As a preference, the preparation method of the liquid vinyl functionalized POSS (Vi-POSS) modified by the low-molecular-weight polysiloxane includes the following steps:
completely dissolving the cage-type octakis(dimethylsiloxy)-T8-silsesquioxane (Q-type H-POSS) in methylbenzene, to obtain a Q-type H-POSS solution; and
adding the Q-type H-POSS solution to a hetero telechelic polydimethylsiloxane solution containing a catalyst tris(pentafluorophenyl)borane, and removing the catalyst, solvent and excess hetero telechelic polydimethylsiloxane after the complete Piers-Rubinsztajn reaction (P-R reaction), to obtain the liquid Vi-POSS.

As a preference, a use amount of the solvent methylbenzene is 8-15 times of mass of Q-type H-POSS.

As a preference, a molar ratio of the Q-type H-POSS to the hetero telechelic polydimethylsiloxane is 1:(8-15).

As a preference, a chemical structural formula of the hetero telechelic polydimethylsiloxane is shown in Formula 2:

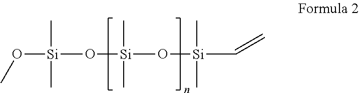

where, n is any integer from 2 to 18.

As a preference, a use amount of the catalyst tris(pentafluorophenyl)borane is 1/10000-5/10000 of mass of the hetero telechelic polydimethylsiloxane.

As a preference, a solvent in a dialysis process is any one of or a combination of a plurality of dichloromethane, 1,4-dioxane, cyclohexane, acetone, chloroform, benzene, methylbenzene and tetrahydrofuran.

The third objective of the present disclosure is to provide liquid silicone rubber modified by liquid POSS, wherein the liquid silicone rubber is obtained by vulcanization molding of the following components in part by mass: 100 parts of vinyl silicone oil, 3-10 parts of hydrogen-containing silicone oil, 2-10 parts of liquid vinyl functionalized cage-type polyhedral oligomeric silsesquioxane according to claim 1, 0.02-0.06 parts of 1-acetenyl-1-cyclohexanol, and a platinum catalyst; wherein a mass concentration of platinum in the platinum catalyst in the liquid silicone rubber components is 10 mg/kg to 26 mg/kg.

As a preference, the vinyl silicone oil is selected from silicone oil containing terminal vinyl and side vinyl at the same time.

As a preference, viscosity of the vinyl silicone oil is 6000 cp to 7000 cp, content of vinyl is 0.19 mmol/g to 0.26 mmol/g, and a molar fraction of phenyl is 15% to 30%.

As a preference, content of active hydrogen of the hydrogen-containing silicone oil is 6.59 mmol/g to 7.70 mmol/g, and a molar fraction of phenyl is 15% to 30%.

As a preference, in the liquid silicone rubber, a molar ratio of a mole number of Si—H groups of components of the hydrogen-containing silicone oil to a total mole number of all alkenyls of components of the vinyl silicone oil and components of the liquid POSS is 1.2 to 1.4.

As a preference, the platinum catalyst is selected from a complex of divinyltetramethyldisiloxane chloroplatinate.

The fourth objective of the present disclosure is to provide a preparation method of liquid silicone rubber modified by liquid POSS. The liquid silicone rubber is prepared through the following steps: evenly mixing vinyl silicone oil and a platinum catalyst at a room temperature, sequentially adding 1-acetenyl-1-cyclohexanol, liquid cage-type polyhedral oligomeric silsesquioxane and hydrogen-containing silicone oil, pouring a mixed sizing material into a mold after evenly mixing the above materials, and performing, by a flat vulcanizing machine, vulcanization molding at 120° C. to 150° C. and 5 MPa to 12 MPa for 1.0 hour to 1.5 hours, to obtain the liquid silicone rubber modified by the liquid POSS.

Compared with the prior art, the present disclosure has the following beneficial effects:
(1) The liquid vinyl functionalized POSS in the present disclosure is reported for the first time, a preparation process is simple, and reaction time is short.
(2) The liquid vinyl functionalized POSS in the present disclosure is a product formed by bonding a cage-type rigid kernel structure and the polysiloxane, has Si—O bond energy of up to 445 kJ/mol on side chains of the POSS, and the side chains thereof have better heat stability than that of common long-carbon-chain side chains, contain vinyl functional groups capable of participating in chemical reactions, and meanwhile have chemical reactivity, which provide a new design thought for the field of modification of organosilicon polymers.
(3) The liquid vinyl functionalized POSS in the present disclosure exists in a liquid form, and has high compatibility with other liquid polymer systems, especially an organosilicon polysiloxane system.
(4) In the present disclosure, a Vi-POSS liquid filler containing silicone vinyl functional groups is adopted as a reinforcing filler and an adjuvant of the liquid silicone rubber, and the finally prepared liquid silicone rubber modified by the POSS has the beneficial effects of good dispersibility (without a solvent), high transparency, good mechanical properties and thermal stability and the like.

### BRIEF DESCRIPTION OF THE DRAWINGS

FIG. 1 is a schematic flowchart of a preparation method of liquid vinyl functionalized POSS in the present disclosure.

FIG. 2 is a 1HNMR spectrogram of liquid vinyl functionalized POSS in the present disclosure.

FIG. 3 is a 29SiNMR spectrogram of liquid vinyl functionalized POSS in the present disclosure.

FIG. 4 is an infrared spectrogram of liquid vinyl functionalized POSS in the present disclosure.

### DETAILED DESCRIPTION OF THE EMBODIMENTS

As mentioned above, in view of the defects in the prior art, the inventor of the present disclosure has proposed the technical solution of the present disclosure after long-term research and extensive practice, which is mainly based on at least: low-molecular-weight polysiloxane is connected to each of eight corners of liquid Vi-POSS, and the polysiloxane is hetero telechelic polydimethylsiloxane with a small degree of polymerization. Wherein, alkoxy at one end and Si—H bonds in H-POSS can undergo a Piers-Rubinsztajn reaction (P-R reaction) under a catalytic action of tris(pentafluorophenyl)borane to form Si—O—Si bonds, such that the polysiloxane is successfully grafted on the POSS; and vinyl at the other end may serve as a functional group to participate in a polymer system through grafting copolymerization and crosslinking copolymerization.

Different from conventional solid POSS, side chains for silicon atoms in molecules in a cage structure of the liquid Vi-POSS are flexible chain links formed by Si—O—Si, such that the Vi-POSS can exist in a liquid form. In addition, heat stability of the POSS is further improved due to high bond energy of the silicon-oxygen bonds in the side chains of the liquid Vi-POSS.

In addition, the POSS used in the present disclosure contains the vinyl functional group, has high compatibility with other liquid polymer systems due to its liquid physical properties, and can be subjected to chemical grafting copolymerization and crosslinking copolymerization with polymers in a directly added manner without adding a solvent, so as to obtain organosilicone materials with good properties.

To make the objectives, the technical solution and the advantages of the present disclosure clearer, the present disclosure will be further described in detail with reference to the accompanying drawings and embodiments. It should be understood that the specific embodiments described herein are only for explaining the present disclosure, but are not for limiting the present disclosure.

In addition, technical features involved in each implementation of the present disclosure described below can be mutually combined as long as they do not conflict.

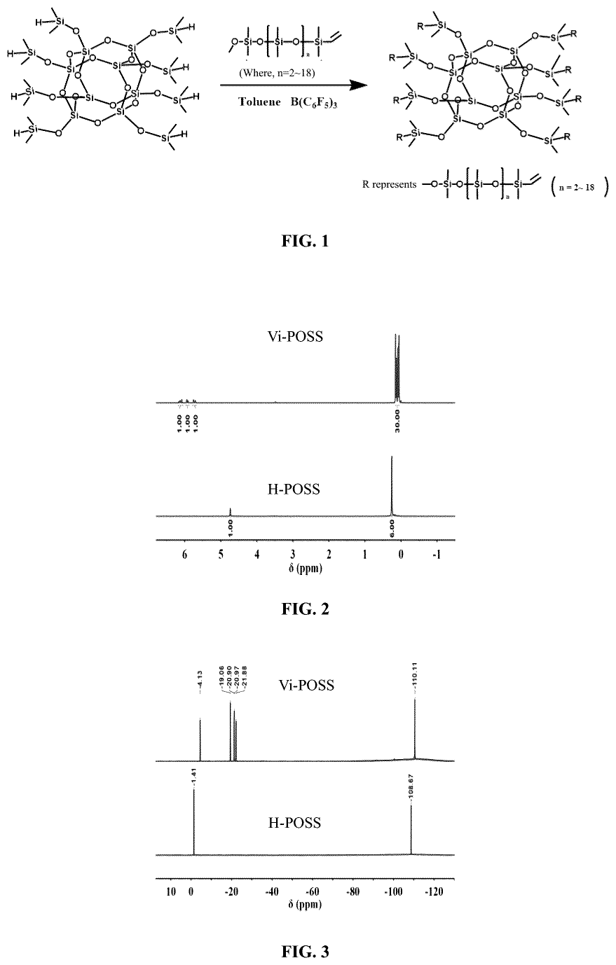

A synthetic route of a preparation method of liquid vinyl functionalized POSS (Vi-POSS) modified by low-molecular-weight polysiloxane is shown in FIG. 1, including the following steps:

Cage-type octakis(dimethylsiloxy)-T8-silsesquioxane (Q-type H-POSS) is fully dissolved in methylbenzene, a methylbenzene solution of a tris(pentafluorophenyl)borane catalyst continues to be added, hetero telechelic polydimethylsiloxane is dropwise added for 1-2 hours under stirring in a water bath at 40° C., and the reaction continues for 2-10 hours after the hetero telechelic polydimethylsiloxane is completely dropwise added, so as to ensure complete reaction of Si—H bonds. (Bubbles can be generated continuously in the process, for the reason that the Si—H bonds in H-POSS and methoxyl in the hetero telechelic polydimethylsiloxane undergo a P-R reaction to generate CH₄)

2-ethylpyridine is added to the above reaction system to damage the catalyst, the solvent is removed through rotary evaporation, remaining low-molecular-weight polysiloxane and other micromolecules are removed through a dialysis bag, and colorless and transparent liquid Vi-POSS (Formula 1) is obtained after vacuum drying at 120° C.

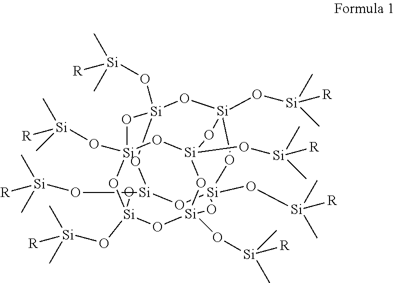

where, R represents a low-molecular-weight polysiloxane group, namely

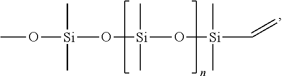

and n is any integer from 2 to 18.

As a preference, a use amount of the solvent methylbenzene is 8-15 times of mass of Q-type H-POSS.

As a preference, a molar ratio of the Q-type H-POSS to the hetero telechelic polydimethylsiloxane is 1:(8-15).

As a preference, a chemical structural formula of the hetero telechelic polydimethylsiloxane is shown in Formula 2:

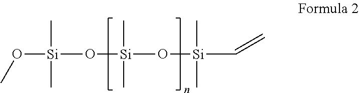

where, n is any integer from 2 to 18.

As a preference, a use amount of the catalyst tris(pentafluorophenyl)borane is 1/10000-5/10000 of mass of the PDMS.

As a preference, a solvent in a dialysis process is any one of or a combination of a plurality of dichloromethane, 1,4-dioxane, cyclohexane, acetone, chloroform, benzene, methylbenzene and tetrahydrofuran.

The present disclosure will be further explained with reference to the embodiments, and the embodiments are used for facilitating the understanding of the present disclosure.

All raw materials used in the present disclosure are commercially available or prepared through conventional methods. The following embodiments are not intended to limit the scope of protection of the present disclosure, but are merely and more clearly descriptive of the technical solution of the present disclosure, and therefore are intended as examples merely.

### Embodiment 1: A Preparation Method of Liquid Vinyl Functionalized POSS, Includes the Following Specific Steps

Hetero telechelic polydimethylsiloxane (n=2) (16 mmol, 5.41 g) is added to a 100 ml single-mouth flask, a 10% tris(pentafluorophenyl)borane methylbenzene solution (5.41 mg) is added, the materials are heated to 40° C. and magnetically stirred, Q-type H-POSS (2 mmol, 2.03 g) is dissolved in 43.28 g of methylbenzene, a methylbenzene solution of the Q-type H-POSS is dropwise added into the single-mouth flask through a constant-pressure dropping funnel, and the reaction continues for 2 hours after dropwise adding for 1 hour. Half a drop of 2-ethylpyridine is added to mixed liquid obtained after the reaction, the solvent is removed through rotary evaporation after stirring for 0.5 hours, the product is washed with methanol three times, obtained liquid is transferred to a dialysis bag and put into cyclohexane for stirring for 24 hours to remove remaining low-molecular-weight polysiloxane and other substances, and colorless and transparent liquid Vi-POSS is obtained after vacuum drying at 120° C.

### Embodiment 2: A Preparation Method of Liquid Vinyl Functionalized POSS, Includes the Following Specific Steps

Hetero telechelic polydimethylsiloxane (n=2) (24 mol, 8.12 g) is added to a 100 ml single-mouth flask, a 10% tris(pentafluorophenyl)borane methylbenzene solution (0.04 g) is added, the materials are heated to 40° C. and magnetically stirred, Q-type H-POSS (2 mmol, 2.03 g) is dissolved in 64.92 g of methylbenzene, a methylbenzene solution of the Q-type H-POSS is dropwise added into the single-mouth flask through a constant-pressure dropping funnel, and the reaction continues for 2 hours after dropwise adding for 2 hours. A drop of 2-ethylpyridine is added to mixed liquid obtained after the reaction, the solvent is removed through rotary evaporation after stirring for 0.5 hours, the product is washed with methanol three times, obtained liquid is transferred to a dialysis bag and put into tetrahydrofuran for stirring for 24 hours to remove remaining low-molecular-weight polysiloxane and other substances, and colorless and transparent liquid Vi-POSS is obtained after vacuum drying at 120° C.

### Embodiment 3: A Preparation Method of Liquid Vinyl Functionalized POSS, Includes the Following Specific Steps

Hetero telechelic polydimethylsiloxane (n=13) (0.03 mol, 34.57 g) is added to a 100 ml single-mouth flask, a 10% tris(pentafluorophenyl)borane methylbenzene solution (34.57 mg) is added, the materials are heated to 40° C. and magnetically stirred, Q-type H-POSS (2 mmol, 2.03 g) is dissolved in 81.15 g of methylbenzene, a methylbenzene solution of the Q-type H-POSS is dropwise added into the single-mouth flask through a constant-pressure dropping funnel, and the reaction continues for 4 hours after dropwise adding for 2 hours. A drop of 2-ethylpyridine is added to mixed liquid obtained after the reaction, the solvent is removed through rotary evaporation after stirring for 0.5 hours, the product is washed with methanol three times, obtained liquid is transferred to a dialysis bag and put into 1,4-dioxane for stirring for 24 hours to remove remaining low-molecular-weight polysiloxane and other substances, and colorless and transparent liquid Vi-POSS is obtained after vacuum drying at 120° C.

### Embodiment 4: A Preparation Method of Liquid Vinyl Functionalized POSS, Includes the Following Specific Steps

Hetero telechelic polydimethylsiloxane (n=18) (0.03 mol, 45.75 g) is added to a 100 ml single-mouth flask, a 10% tris(pentafluorophenyl)borane methylbenzene solution (91.50 mg) is added, the materials are heated to 40° C. and magnetically stirred, Q-type H-POSS (2 mmol, 2.03 g) is dissolved in 64.92 g of methylbenzene, a methylbenzene solution of the Q-type H-POSS is dropwise added into the single-mouth flask through a constant-pressure dropping funnel, and the reaction continues for 10 hours after dropwise adding for 2 hours. A drop of 2-ethylpyridine is added to mixed liquid obtained after the reaction, the solvent is removed through rotary evaporation after stirring for 0.5 hours, the product is washed with methanol three times, obtained liquid is transferred to a dialysis bag and put into acetone for stirring for 24 hours to remove remaining low-molecular-weight polysiloxane and other substances, and colorless and transparent liquid Vi-POSS is obtained after vacuum drying at 120° C.

FIG. 2 shows a 1HNMR spectrogram of liquid Vi-POSS in Embodiments 1-2. By comparing absorption peaks of Vi-POSS and H-POSS, a characteristic absorption peak of Si—H at delta=4.72 in the Vi-POSS disappears, a characteristic absorption peak of Si—Vi at delta=5.55-6.01 appears, and an area ratio of Si—Vi to Si—CH₃ is 1:10, which indicates synthesis of the Vi-POSS.

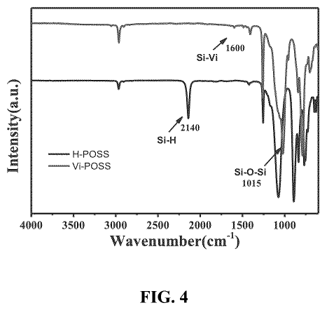

FIG. 3 shows a ²⁹SiNMR spectrogram of liquid Vi-POSS in Embodiments 1-2. By comparing absorption peaks of Vi-POSS and H-POSS, five absorption peaks at delta=−4.13, δ=−19.06, δ=−20.90, δ=−20.97 and δ=−21.88 correspond to Si atoms in five OSi(CH₃)₂— chain links connected to a POSS side group. Synthesis of the Vi-POSS is further indicated.

FIG. 4 shows an infrared spectrogram of liquid Vi-POSS in Embodiments 1-2. It can be shown from the figure that a characteristic absorption peak of Si—H at 2160 cm⁻¹ in a Vi-POSS monomer disappears, a stretching vibration absorption peak of —CH═CH₂ at 1600 cm⁻¹ appears, and a stretching vibration absorption peak of Si—O—Si in a typical POSS cage-type framework structure exists at 1015 cm⁻¹.

### Application Example 1

Liquid silicone rubber modified by liquid Vi-POSS, includes the following components in parts by mass: 100 parts of vinyl silicone oil (viscosity of 6500 cp, content of vinyl of 0.23 mmol/g, and molar fraction of phenyl of 15%), 8.66 parts of hydrogen-containing silicone oil (content of active hydrogen of 4.56 mmol/g, and molar fraction of phenyl of 15%), 2.22 parts of liquid Vi-POSS, 0.36 parts of a methylbenzene solution (concentration of 3000 ppm) of a platinum catalyst of a complex of divinyltetramethyldisiloxane chloroplatinate, and 0.35 parts of 1-acetenyl-1-cyclohexanol.

The vinyl silicone oil and the catalyst are evenly mixed at a room temperature, the 1-acetenyl-1-cyclohexanol, the liquid Vi-POSS and the hydrogen-containing silicone oil are sequentially added, a mixed sizing material is poured into a mold after evenly mixing the above materials, and vulcanization molding is performed by a flat vulcanizing machine at 120° C. for 1.5 hours, to obtain liquid silicone rubber 1 modified by liquid POSS.

### Application Example 2

Liquid silicone rubber modified by liquid Vi-POSS, includes the following components in parts by mass: 100 parts of vinyl silicone oil (viscosity of 6500 cp, content of vinyl of 0.23 mmol/g, and molar fraction of phenyl of 20%), 9.46 parts of hydrogen-containing silicone oil (content of active hydrogen of 4.56 mmol/g, and molar fraction of phenyl of 20%), 3.39 parts of liquid Vi-POSS, 0.36 parts of a methylbenzene solution (concentration of 3000 ppm) of a platinum catalyst of a complex of divinyltetramethyldisiloxane chloroplatinate, and 0.35 parts of 1-acetenyl-1-cyclohexanol.

The vinyl silicone oil and the catalyst are evenly mixed at a room temperature, the 1-acetenyl-1-cyclohexanol, the liquid Vi-POSS and the hydrogen-containing silicone oil are sequentially added, a mixed sizing material is poured into a mold after evenly mixing the above materials, and vulcanization molding is performed by a flat vulcanizing machine at 120° C. for 1.5 hours, to obtain liquid silicone rubber 2 modified by liquid POSS.

### Application Example 3

Liquid silicone rubber modified by liquid Vi-POSS, includes the following components in parts by mass: 100 parts of vinyl silicone oil (viscosity of 6500 cp, content of vinyl of 0.23 mmol/g, and molar fraction of phenyl of 25%), 10.28 parts of hydrogen-containing silicone oil (content of active hydrogen of 4.56 mmol/g, and molar fraction of phenyl of 25%), 4.60 parts of liquid Vi-POSS, 0.36 parts of a methylbenzene solution (concentration of 3000 ppm) of a platinum catalyst of a complex of divinyltetramethyldisiloxane chloroplatinate, and 0.35 parts of 1-acetenyl-1-cyclohexanol.

The vinyl silicone oil and the catalyst are evenly mixed at a room temperature, the 1-acetenyl-1-cyclohexanol, the liquid Vi-POSS and the hydrogen-containing silicone oil are sequentially added, a mixed sizing material is poured into a mold after evenly mixing the above materials, and vulcanization molding is performed by a flat vulcanizing machine at 120° C. for 1.5 hours, to obtain liquid silicone rubber 3 modified by liquid POSS.

### Application Example 4

Liquid silicone rubber modified by liquid Vi-POSS, includes the following components in parts by mass: 100 parts of vinyl silicone oil (viscosity of 6500 cp, content of vinyl of 0.23 mmol/g, and molar fraction of phenyl of 25%), 11.14 parts of hydrogen-containing silicone oil (content of active hydrogen of 4.56 mmol/g, and molar fraction of phenyl of 25%), 5.85 parts of liquid Vi-POSS, 0.36 parts of a methylbenzene solution (concentration of 3000 ppm) of a platinum catalyst of a complex of divinyltetramethyldisiloxane chloroplatinate, and 0.35 parts of 1-acetenyl-1-cyclohexanol.

The vinyl silicone oil and the catalyst are evenly mixed at a room temperature, the 1-acetenyl-1-cyclohexanol, the liquid Vi-POSS and the hydrogen-containing silicone oil are sequentially added, a mixed sizing material is poured into a mold after evenly mixing the above materials, and vulcanization molding is performed by a flat vulcanizing machine at 120° C. for 1.5 hours, to obtain liquid silicone rubber 4 modified by liquid POSS.

### Application Example 5

Liquid silicone rubber modified by liquid Vi-POSS, includes the following components in parts by mass: 100 parts of vinyl silicone oil (viscosity of 6500 cp, content of vinyl of 0.23 mmol/g, and molar fraction of phenyl of 30%), 12.03 parts of hydrogen-containing silicone oil (content of active hydrogen of 4.56 mmol/g, and molar fraction of phenyl of 30%), 7.15 parts of liquid Vi-POSS, 0.36 parts of a methylbenzene solution (concentration of 3000 ppm) of a platinum catalyst of a complex of divinyltetramethyldisiloxane chloroplatinate, and 0.35 parts of 1-acetenyl-1-cyclohexanol.

The vinyl silicone oil and the catalyst are evenly mixed at a room temperature, the 1-acetenyl-1-cyclohexanol, the liquid Vi-POSS and the hydrogen-containing silicone oil are sequentially added, a mixed sizing material is poured into a mold after evenly mixing the above materials, and vulcanization molding is performed by a flat vulcanizing machine at 120° C. for 1.5 hours, to obtain liquid silicone rubber 5 modified by liquid POSS.

### Comparative Application Example 1: Pure Liquid Silicone Rubber without Liquid POSS

The pure liquid silicone rubber without the liquid POSS, includes the following components in part by mass: 100 parts of vinyl silicone oil (viscosity of 6500 cp, content of vinyl of 0.23 mmol/g, and molar fraction of phenyl of 25%), 7.14 parts of hydrogen-containing silicone oil (content of active hydrogen of 4.56 mmol/g, and molar fraction of phenyl of 25%), 0.54 parts of a methylbenzene solution (concentration of 3000 ppm) of a platinum catalyst of a complex of divinyltetramethyldisiloxane chloroplatinate, and 0.28 parts of 1-acetenyl-1-cyclohexanol.

The vinyl silicone oil and the catalyst are evenly mixed at a room temperature, the 1-acetenyl-1-cyclohexanol, Vi-POSS and the hydrogen-containing silicone oil are sequentially added, a mixed sizing material is poured into a mold after evenly mixing the above materials, and vulcanization molding is performed by a flat vulcanizing machine at 150° C. for 1.0 hour, to obtain liquid silicone rubber 6 modified by the liquid POSS.

### Comparative Application Example 2: Liquid Silicone Rubber Reinforced by Solid Q8 Type Vi-POSS

(1) Preparation of solid Q8 type Vi-POSS

6.25 g of tetraethyl orthosilicate (0.03 mol), 0.54 ml of distilled water (0.03 mol) and 5.43 g of tetramethylammonium hydroxide pentahydrate (0.03 mol) are dissolved in 50 ml of methanol, a hydrolytic condensation reaction is performed in a water bath at 10° C. for 24 hours, to obtain cage-type octamethylammonium silicate, then 14.48 g of dimethylvinylchlorosilane (0.12 mol) is added therein, and a reaction is performed in a water bath at 10° C. for 12 hours, to obtain cage-type octakis(dimethylsiloxy)-T8-silsesquioxane (Q8 type Vi-POSS).
(2) The liquid silicone rubber reinforced by the solid Q8 type Vi-POSS, includes the following components in parts by mass: 100 parts of vinyl silicone oil (viscosity of 6500 cp, content of vinyl of 0.23 mmol/g, and molar fraction of phenyl of 25%), 5.01 parts of hydrogen-containing silicone oil (content of active hydrogen of 4.56 mmol/g, and molar fraction of phenyl of 25%), 1.46 parts of solid Q8 type Vi-POSS, 0.36 parts of a methylbenzene solution (concentration of 3000 ppm) of a platinum catalyst of a complex of divinyltetramethyldisiloxane chloroplatinate, and 0.35 parts of 1-acetenyl-1-cyclohexanol. The liquid silicone rubber reinforced by the solid Q8 type Vi-POSS is prepared through the following specific steps:

The vinyl silicone oil and the catalyst are evenly mixed at a room temperature, the 1-acetenyl-1-cyclohexanol, the solid Q8 type Vi-POSS and the hydrogen-containing silicone oil are sequentially added, a mixed sizing material is poured into a mold after evenly mixing the above materials, and vulcanization molding is performed by a flat vulcanizing machine at 120° C. for 1.5 hours, to obtain liquid silicone rubber 7 modified by solid vinyl POSS.

### Test Example

Tensile strength, elongation at break, Shore hardness, degree of swelling, viscosity and light transmittance of the liquid silicone rubber 1 modified by the liquid Vi-POSS to the liquid silicone rubber 5 modified by the liquid Vi-POSS prepared in Application Examples 1 to 5, the liquid silicone rubber 6 without the liquid POSS prepared in Comparative Application Example 1, and the liquid silicone rubber 7 modified by the solid Vi-POSS prepared in Comparative Application Example 2 are tested, which are shown in Table 1.

The tensile strength and the elongation at break were tested by a universal tester according to GB/T 528-2009 standard; the hardness was tested by a hardometer according to GB/T 531-2008 standard; the viscosity was tested by a CA-P2000+cone-plate viscometer; a refractive index was tested by a 2WAJ type Abbe refractometer; the light transmittance was tested by a 752 ultraviolet and visible spectrophotometer; and a weight loss temperature was tested by a thermal gravimetric analyzer in a nitrogen atmosphere.

TABLE 1
Comparison of properties of liquid silicone rubber prepared in Application
Examples 1 to 5 and Comparative Application Examples 1 to 2

| | | | | | | Maximum | |
|---|---|---|---|---|---|---|---|
| | | | | | 5% weight | thermal | 600° C. |
| | Tensile | Elongation | | Light | loss | weight loss | residual |
| | strength | at break | Hardness | transmittance | temperature | temperature | rate |
| No. | (MPa) | (%) | (A) | (%) | (° C.) | (° C.) | (%) |
| Embodiment 1 | 0.51 +/− 0.5 | 82 +/− 23 | 37.84 | ≥91.00 | 408.95 | 495.15 | 67.87 |
| Embodiment 2 | 0.70 +/− 0.6 | 104 +/− 18 | 39.03 | ≥91.00 | 413.37 | 497.99 | 68.34 |
| Embodiment 3 | 1.98 +/− 1.0 | 205 +/− 14 | 40.61 | ≥91.00 | 418.32 | 510.88 | 72.65 |
| Embodiment 4 | 1.65 +/− 0.7 | 166 +/− 17 | 42.33 | ≥91.00 | 424.34 | 536.64 | 75.23 |
| Embodiment 5 | 1.41 +/− 0.8 | 136 +/− 20 | 44.43 | ≥91.00 | 423.34 | 513.72 | 76.78 |
| Comparative | 0.32 +/− 0.5 | 67 +/− 15 | 34.87 | ≥91.00 | 391.58 | 429.83 | 65.24 |
| Example 1 | | | | | | | |
| Comparative | 0.44 +/− 0.2 | 83 +/− 18 | 41.15 | ≤62.00 | 400.50 | 479.23 | 68.65 |
| Example 2 | | | | | | | |

It can be seen from Table 1 that compared with the pure liquid silicone rubber in Comparative Application Example 1 and the liquid silicone rubber reinforced by the added solid POSS in Comparative Application Example 2, the liquid silicone rubber reinforced by the liquid Vi-POSS in Application Examples 1 to 5 has excellent comprehensive mechanical properties, and high tensile strength (0.51+/−0.5 to 1.41+/−0.8 Mpa), elongation at break (82+/−23 to 136+/−20%), and hardness (37.84 A to 44.43 A). Thermal stability properties of the liquid silicone rubber reinforced by the liquid Vi-POSS were obviously improved. It can be seen from Table 1 that after adding the liquid Vi-POSS, the 5% weight loss temperature of the liquid silicone rubber could be increased from 391.58° C. to 408.95° C. to 424.34° C., and the 600° C. residual rate could reach 76.78% to the maximum. It can also be seen from Table 1 that the light transmittance of the silicone rubber was not greatly affected by adding the liquid Vi-POSS, which was basically stabilized within a range of ≥91.00%, and light transmittance properties were excellent compared with those of the liquid silicone rubber reinforced by the solid POSS.

The described embodiments are only a part of embodiments of the present disclosure rather than all embodiments. All other embodiments obtained by those skilled in the art or in the related art without inventive breakthrough based on the embodiments in the present disclosure fall within the protection scope of the present disclosure.

What is claimed is:

1. Liquid vinyl functionalized cage-type polyhedral oligomeric silsesquioxane, wherein a structural formula of the liquid vinyl functionalized cage-type polyhedral oligomeric silsesquioxane is shown in Formula 1: 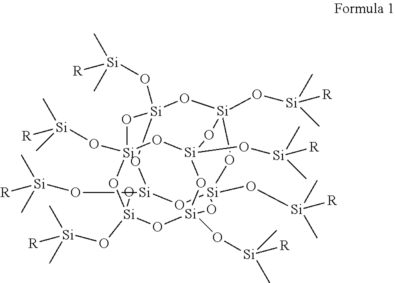
wherein, R represents 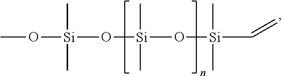
and n is any integer from 2 to 18.

2. A preparation method of the liquid vinyl functionalized cage-type polyhedral oligomeric silsesquioxane according to claim 1, wherein the preparation method comprises the following steps:
under a catalytic action of tris(pentafluorophenyl)borane, making cage-type octakis(dimethylsiloxy)-T8-silsesquioxane and hetero telechelic polydimethylsiloxane undergo a Piers-Rubinsztajn reaction, to obtain liquid Vi-POSS; wherein
a chemical structural formula of the hetero telechelic polydimethylsiloxane is shown in Formula 2: 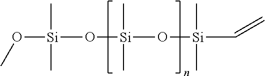
wherein, n is any integer from 2 to 18.

3. The preparation method according to claim 2, wherein the preparation method specifically comprises the steps:
completely dissolving the cage-type octakis(dimethylsiloxy)-T8-silsesquioxane in a solvent methylbenzene, to obtain a Q-type H-POSS solution; and
adding the Q-type H-POSS solution to a hetero telechelic polydimethylsiloxane solution containing a catalyst tris(pentafluorophenyl)borane, and removing the catalyst, solvent and excess hetero telechelic polydimethylsiloxane after the complete Piers-Rubinsztajn reaction, to obtain the liquid Vi-POSS.

4. The preparation method according to claim 3, wherein a use amount of the solvent methylbenzene is 8-15 times of mass of Q-type H-POSS.

5. The preparation method according to claim 3, wherein a molar ratio of the cage-type octakis(dimethylsiloxy)-T8-silsesquioxane to polysiloxane is 1:(8-15).

6. The preparation method according to claim 3, wherein a use amount of the catalyst tris(pentafluorophenyl)borane is 1/10000-5/10000 of mass of the hetero telechelic polydimethylsiloxane.

7. The preparation method according to claim 3, wherein a solvent in a dialysis process is any one of or a combination of a plurality of dichloromethane, 1,4-dioxane, cyclohexane, acetone, chloroform, benzene, methylbenzene and tetrahydrofuran.

8. Liquid silicone rubber modified by liquid POSS, wherein the liquid silicone rubber is obtained by vulcanization molding of the following components in part by mass: 100 parts of vinyl silicone oil, 3-10 parts of hydrogen-containing silicone oil, 2-10 parts of liquid vinyl functionalized cage-type polyhedral oligomeric silsesquioxane according to claim 1, 0.02-0.06 parts of 1-acetenyl-1-cyclohexanol, and a platinum catalyst; wherein a mass concentration of platinum in the platinum catalyst in the liquid silicone rubber components is 10 mg/kg to 26 mg/kg.

9. The liquid silicone rubber modified by the liquid POSS according to claim 8, wherein the vinyl silicone oil is selected from silicone oil containing terminal vinyl and side vinyl at the same time.

10. The liquid silicone rubber modified by the liquid POSS according to claim 8, wherein viscosity of the vinyl silicone oil is 6000 cp to 7000 cp, content of vinyl is 0.19 mmol/g to 0.26 mmol/g, and a molar fraction of phenyl is 15% to 30%.

11. The liquid silicone rubber modified by the liquid POSS according to claim 8, wherein content of active hydrogen of the hydrogen-containing silicone oil is 6.59 mmol/g to 7.70 mmol/g, and a molar fraction of phenyl is 15% to 30%.

12. The liquid silicone rubber modified by the liquid POSS according to claim 8, wherein in the liquid silicone rubber, a molar ratio of a mole number of Si—H groups of components of the hydrogen-containing silicone oil to a total mole number of all alkenyls of components of the vinyl silicone oil and components of the liquid POSS is 1.2 to 1.4.

13. The liquid silicone rubber modified by the liquid POSS according to claim 8, wherein the platinum catalyst is selected from a complex of divinyltetramethyldisiloxane chloroplatinate.
